(19) United States
(12) Patent Application Publication
(10) Pub. No.: US 2010/0103183 A1
(43) Pub. Date: Apr. 29, 2010

(54) REMOTE MULTIPLE IMAGE PROCESSING APPARATUS

(76) Inventors: Hung-Ming LIN, Hsinchu City (TW); Hung-Ju HUANG, Hsinchu City (TW); Jen-Min YUAN, Hsinchu City (TW); Ming-Chi BAI, Hsinchu City (TW); Ya-Cheng CHEN, Hsinchu City (TW)

Correspondence Address: Muncy, Geissler, Olds & Lowe, PLLC, P.O. BOX 1364, FAIRFAX, VA, 22038-1364, US

(21) Appl. No.: 12/256,944

(22) Filed: Oct. 23, 2008

(51) Int. Cl. G06T 9/00

(52) U.S. Cl. 345/555

(57) ABSTRACT

A remote multiple image processing apparatus comprises a graphic processing unit, a memory unit, an image compression unit, a transmission unit and a transmission medium. The graphic processing unit receives at least an image frame including a plurality of image blocks, and determines the degree of the difference between the current input image block and the previous input image block. The memory unit, coupling to the graphic processing unit, stores the image blocks. The image compression unit, coupling to the memory unit, compresses the image blocks and generates at least a compressed datum. The transmission unit, coupling to the image compression unit, transforms the compressed datum into at least a data packet. The transmission medium outputs the data packet. The remote multiple image processing apparatus uses the compression technique to allow a client sharing the resources of graphic processing unit so as to get multiple use benefits.

### BACKGROUND OF THE INVENTION

(a) Field of the Invention

The invention relates to a remote multiple image processing apparatus, particularly to a remote multiple image processing apparatus for multiple users.

(b) Description of the Related Art

Currently, a usual computer can not be operated remotely by multiple users under the three dimensional image processing mode due to the limitations such as the graphic card and the transmission bandwidth limitation, etc. Therefore, it is inconvenient in use for some locations, such as a small office or home local area network.

### BRIEF SUMMARY OF THE INVENTION

Therefore, in order to solve the above-mentioned problem, one object of the invention is to provide a remote multiple image processing apparatus via usual transmission cables, such as network cables, to transmit data.

One object of the invention is to provide a remote multiple image processing apparatus to reduce production cost.

One object of the invention is to provide a remote multiple image processing apparatus to reduce purchasing cost for consumers.

One object of the invention is to provide a remote multiple image processing apparatus to greatly extend the transmission distance.

One object of the invention is to provide a remote multiple image processing apparatus to reduce bandwidth usage effectively.

One object of the invention is to provide a remote multiple image processing apparatus for multiple users simultaneously.

One embodiment of the invention provides a remote multiple image processing apparatus. The remote multiple image processing apparatus comprises a graphic processing unit, a memory unit, an image compression unit, a transmission unit, and a transmission medium. The graphic processing unit receives at least an image frame including a plurality of image blocks, and determines the degree of the difference between the current input image block and the previous input image block. The memory unit, coupling to the graphic processing unit, stores the current image blocks. The image compression unit, coupling to the memory unit, compresses the image blocks to generate a compressed datum. The transmission unit, coupling to the image compression unit, transforms the compressed datum into at least a data packet. The transmission medium outputs the data packet.

Furthermore, another embodiment of the invention provides a remote multiple image processing method. The method comprises the following steps. At first, at least an image frame including a plurality of image blocks is received. The degree of the difference between the current input image block and the previous input image block is determined. The current input image block and the previous input image block each comprise a color datum and a flag datum. Then, the current input image block is stored and compressed to generate a compressed datum. Following that, the compressed datum is transformed into a data packet and then the data packet is transmitted. It should be noted that, when the color data of the current input image block and the previous input image block are different, the flag data are updated stored in the memory unit. Whether the current input image block is compressed or not is determined by the flag data.

One embodiment of the invention provides a remote multiple image processing apparatus. The remote multiple image processing apparatus comprises a de-multiplexer and at least one client processing circuit. The de-multiplexer receives a data packet and outputs the data packet according to a command. The client processing circuit comprises at least a transmission unit and at least a de-compression unit. The transmission unit receives the data packet and transforms the data packet into a compressed datum. The de-compression unit, coupling to the transmission unit, decompresses the compressed datum to generate an image frame datum.

The remote multiple image processing apparatus and method thereof according to the embodiments of the invention determine the difference between the current input image block and the previous input image block, use the compression unit to compress the block being different, and finally use the transmission unit for output. Accordingly, the remote multiple image processing apparatus and method thereof according to the embodiments of the invention not only reduce the bandwidth usage during transmission but also perform long-distance data transmission via the transmission medium, such as network cables or optical fibers on the premise of low cost. Furthermore, in the transmission device of the embodiment, the physical layer circuit can be implemented by the current device having the physical layer circuit to achieve the purpose of reducing production cost.

On the other hand, the server and the client of the remote multiple image processing apparatus utilize the transmission medium, de-multiplexer, and client processing circuit to operate in coordination so that each remote user can share the resource of the same computer only by connecting the display device with a remote client processing apparatus. Since the server of the remote multiple image processing apparatus utilizes the compression technology to accelerate the transmission rate, multiple users can remotely share the resource of the same computer under the three dimensional image mode so that each display device can function like a computer for each user. Thus, for an office or home local area network, multiple computers and multiple display devices are not needed and space for multiple computers can be saved because only one computer and multiple display devices are needed. The usage of apparatuses can be used simultaneous and more effectively. Therefore, the remote multiple image processing apparatus and method thereof according to the embodiments of the invention can greatly reduce design budget and production cost under the same or better transmission efficiency as that in the prior technology.

### BRIEF DESCRIPTION OF THE DRAWINGS

FIG. 1A shows a schematic diagram illustrating the server, the client, and the remote multiple image processing apparatus according to one embodiment of the invention.

FIG. 1B shows a schematic diagram illustrating the server of the remote multiple image processing apparatus according to one embodiment of the invention.

FIG. 1C shows a schematic diagram illustrating the image data of the embodiment shown in FIG. 1B.

FIG. 2 shows a flow chart illustrating the remote multiple image processing method according to one embodiment of the invention.

FIG. 3 shows a schematic diagram illustrating the client of the remote multiple image processing apparatus according to one embodiment of the invention.

### DETAILED DESCRIPTION OF THE INVENTION

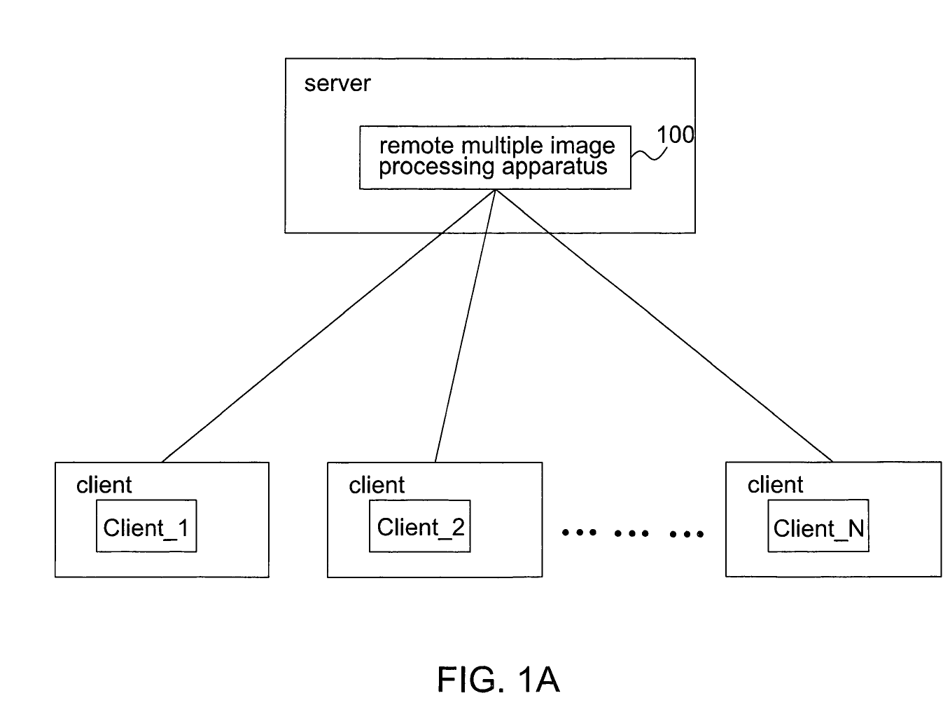

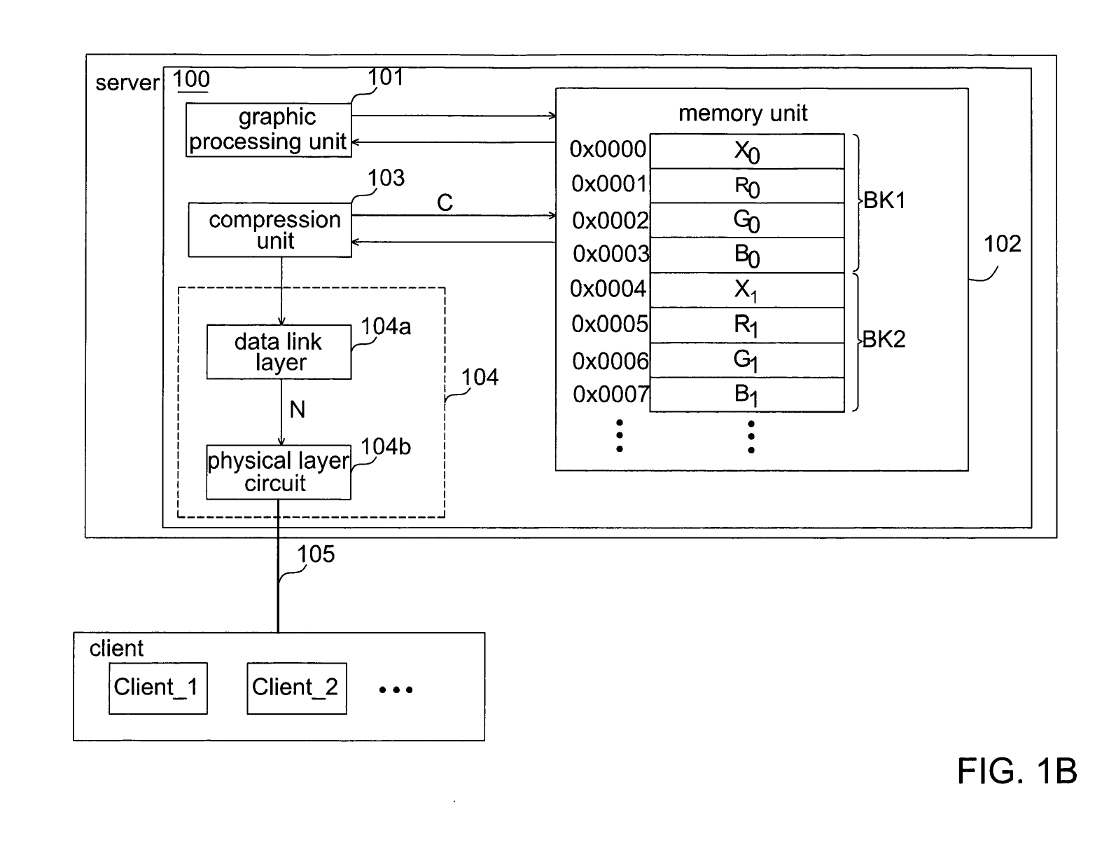

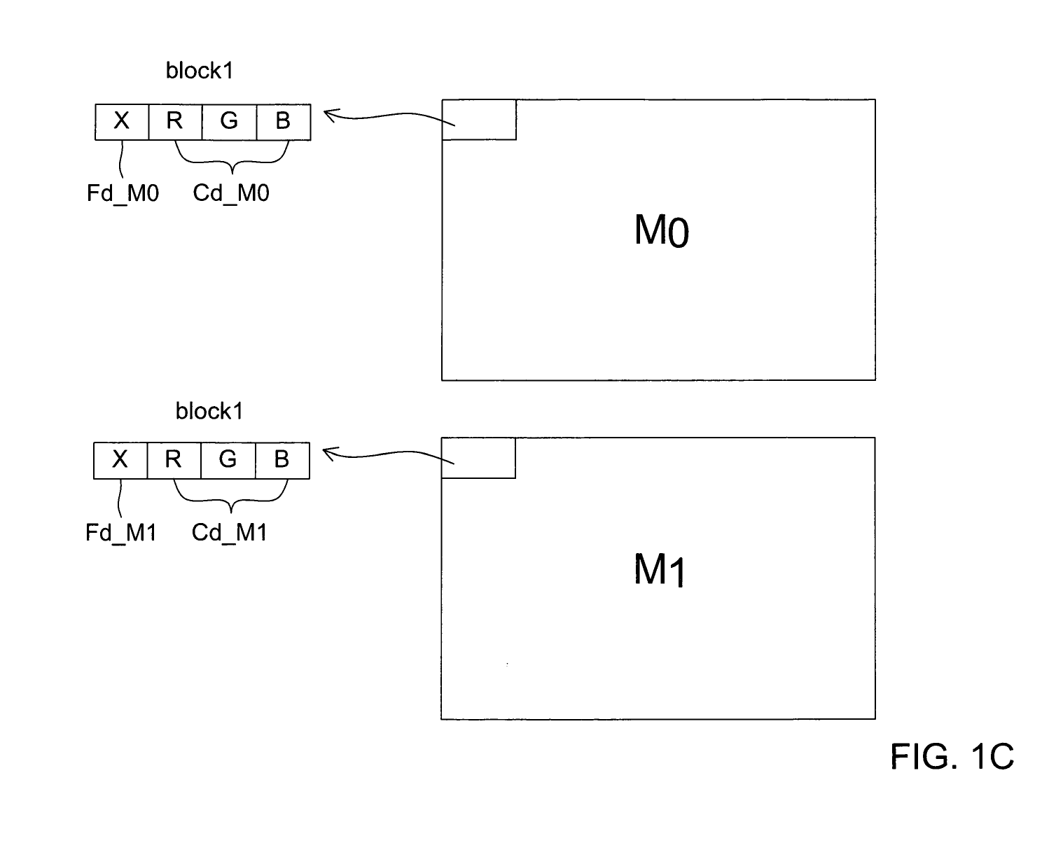

FIG. 1A shows a schematic diagram illustrating the server, the client, and the remote multiple image processing apparatus according to one embodiment of the invention where the remote multiple image processing apparatus 100 can be used for multiple users to process multiple images.

Please refer to FIGS. 1B and 1C simultaneously. FIG. 1B shows a schematic diagram illustrating the server of the remote multiple image processing apparatus according to one embodiment of the invention. FIG. 1C shows a schematic diagram illustrating the image data of the embodiment shown in FIG. 1B. The remote multiple image processing apparatus 100 can be applied to transmission with the specification of the peripheral component interconnect express (PCIe; PCI express), or peripheral component interconnect (PCI) or any other current or future specification.

The server of the remote multiple image processing apparatus 100 comprises a graphic processing unit 101, a memory unit 102, a compression unit 103 and a transmission unit 104. The coupling relationship of the above units is shown in FIG. 1B. In one embodiment, the memory unit 102 is implemented by a dynamic random access memory (DRAM). The memory unit 102 is not limited to the above given example and can be any current or future memory. It should be noted that the PCIe interface is used hereafter for illustration convenience. Certainly, the embodiment of the invention is not limited to the PCIe interface. In another embodiment, the PCI interface or any interface with current specification or specification to be developed in the future.

The graphic processing unit 101 receives an input frame Mn (n is an integer and less than infinity) via the PCIe interface. The input frame Mn comprises a plurality of image blocks BK. In this embodiment, as shown in FIG. 1C, each image block BK represents a pixel and each pixel comprises four 8-bit data, that is, 4 bytes. Each pixel comprises a color data portion Cd and a flag data portion Fd where red, green, blue (RGB) primary color data belong to the color data portion Cd, Cd_M0 and Cd_M1 shown in FIG. 1C and X data belong to the flag data portion Fd, Fd_M0 and Fd_M1 shown in FIG. 1C.

Since the server of the remote multiple image processing apparatus 100 needs to serve multiple users (Client_1˜Client_n), the image data volume for transmission is very large. In one embodiment, in order to normally transmit the image data, the flag data portion Fd is used to determine how to compress so as to achieve the purpose of saving bandwidths. Certainly, the compression method is not limited to the above example and any current or future compression method can be used.

For example, the detailed operational principle of using a flag to compress data is given in the following.

At first, the graphic processing unit 101 receives an input frame M0 via the PCIe interface and stores Cd_M0 and Fd_M0 of the frame M0 in the memory unit 102. At the same time, the data of the frame M0 are transmitted via the compression unit 103, the transmission unit 104 and the transmission medium 105 to the client for display.

In one embodiment, the method for storing data in the memory unit 102 is shown on the right-hand side of FIG. 1B. It is assumed that the first image block BK1 of the input frame M0 is stored at the address 0x0000˜0x0003, the second image block BK2 is stored at the address 0x0004˜0x0007, and the data X 0 and X 1 are preset to be logic 0. It should be noted that in another embodiment the method for storing other image blocks is to store consecutively after the second image block BK2 or store at any other address, not shown in the figure, in the memory unit.

Then, the graphic processing unit 101 again receives an input frame M1 and compares the color datum Cd_M1 of the input frame M1 with the color datum Cd_M0 of the frame M0 temporarily stored in the memory unit 102. That is, the pixel of the input frame M1 is compared to the corresponding pixel at the same position of the input frame M0. For example, when the color datum of the first image block BK1 of the input frame M0 is the same as that of the first image block BK1 of the input frame M1, no storing or updating operation will be done for the color datum Cd_M0 and the flag datum Fd_M0 stored in the memory unit 102 and thus the flag datum Fd_M0 is still logic 0.

On the contrary, when the color datum of the first image block BK1 of the input frame M 1 is different from that of the first image block BK1 of the input frame M 0, the color datum Cd_M0 and the flag datum Fd_M0 stored in the memory unit 102 are updated and thus the color datum Cd_M0 is updated to Cd_M1 and the flag datum Fd_M0 is updated to Fd_M1. It should be noted that those who are skilled in the art should understand that any other frame M can be processed in the same manner as described in the above. Thus, the details will not be given hereafter.

As described in the above, the compression unit 103 determines the image block BK with the flag datum Fd being logic 1 in the memory unit 102 and then compresses the image block BK with the flag datum Fd being logic 1 to generate a compressed datum C. Then, the compressed datum C is transmitted to the data link layer 104a to be appended with a header and a cyclic redundancy check (CRC) or error correction code (ECC) and then assembled to generate a data packet N for being transmitted to the physical layer circuit 104b. The physical layer circuit 104b then processes the transmission of the data packet N via the transmission medium 105. On the other hand, the image block being logic 0 in the memory unit 102 will not be compressed by the compression unit 103 and does not need to be repeatedly transmitted by the transmission unit 104. Thus, the server of the remote multiple image processing apparatus 100 does not have to repeatedly process the same content of the image data and transmit the same data to the client so as to accelerate the processing speed and reduce the bandwidth usage.

It should be noted that the method for compressing the image blocks BK1˜BKn by the compression unit 103 according to the embodiment can use a sequentially compressing, non-sequentially compressing, compressing m blocks (m is a positive integer and m≦n) each time, selectively compressing (compressing with a preset priority), or any current or future compression method. The physical layer circuit 104b of the embodiment can be implemented by the current device having the physical layer circuit, such as a modulator-demodulator (modem), IP sharing, router, etc., with or without modification. Therefore, the design budget and production cost can be reduced. Certainly, the physical layer circuit 104b can also be designed by research staff or be implemented by the circuit having the physical layer to be developed in the future. Besides, the physical layer circuit 104b of the embodiment can be operated at various different transmission rates, such as 10M bit, 100M bit, 1 giga bit or higher transmission rate (transmission rate can be preset by the designer). The transmission medium 105 of the embodiment can be the network cable or optical fiber. For example, the cables with the common specification of CAT-5, CAT-5e, CAT-6 or other higher rate can be used because of low cost. Therefore, production cost can be greatly reduced under the same or better transmission efficiency compared to the prior art. Certainly, the invention is not limited to this example and can use any current or future popular transmission cables. In one embodiment, the data packet N is a network packet or a packet without internet protocol (IP) data while in another embodiment the data packet N can be any data packet with any current or future specification.

In addition, in another embodiment, the image block BK also includes a preset number of pixels. In other words, If any pixel of the image block BK1 (including a preset number of pixels) of the input frame M1 is different from the corresponding pixel of the image block BK1 (including a preset number of pixels) of the input frame M0, the compression unit 103 compresses the image block BK1 directly to generate a compressed datum C and transmits the compressed datum C to the transmission unit 104 for processing to generate the data packet N for output. On the contrary, when the data of the image block BK1 (including a preset number of pixels) of the input frame M1 are the same as those of the image block BK1 (including a preset number of pixels) of the input frame M0, the compression unit 103 does not perform compression and the transmission unit 104 does not transmit any data packet, either, in order to reduce the bandwidth usage.

In another embodiment, the image block BK may be a whole frame. If any pixel in the input frame M1 is different from that in the input frame M0, the compression unit 103 compresses the input frame M1 directly and the compressed datum C is processed by the transmission unit 104 to generate a data packet N and the data packet N is outputted. On the contrary, if all of the pixel data of the input frame M1 are same as those of the input frame M0, the compression unit 103 does not perform compression and the transmission unit 104 does not transmit any data packet, either, in order to reduce the bandwidth usage in the manner.

In another embodiment, the image block BK may be a whole frame. If any pixel in the input frame M1 is different from that in the input frame M0, the compression unit 103 does not perform the compression. The compression unit 103 only narrows down the area of the image block BK into the area having different pixels between the input frame M1 and the input frame M0. Then, the compression unit 103 may compress the areas having different pixels between the frame M1 and M0 so as to reduce the bandwidth usage.

It should be noted that the above memory unit 102 is implemented by the dynamic random access memory (DRAM). Certainly, the memory unit 102 can be implemented by a built-in frame buffer in the graphic processing unit 101. In other words, the screen image for each different user (client) is processed by the same graphic processing unit 101 and then stored in the different position of its built-in frame buffer for subsequent processing like compression and transmission. The operational principles for compression and transmission are the same as the above and will not be described hereafter.

Furthermore, in this embodiment, the storage position of the flag Fd is from the additional memory space while in another embodiment the bit not being used by the pixel can be used to store the flag Fd. For example, if the screen is full color, red, green, and blue (R/G/B) primary colors are represented by 8 bits and thus 24 bits are used. If one pixel is represented by 32 bits, there are 8 bits available. The remote multiple image processing apparatus according to the embodiment of the invention can use these available spaces to store the flag Fd so that the hardware cost can be reduced.

On the other hand, in one embodiment, the flag Fd does not need to record the change of every pixel precisely. In order to accelerate the processing speed, the flag Fd indicates the combined change of a block of the frame, a row of the frame, or several rows of the frame. As long as there is change on some pixel within these regions, the flag of the whole region can be set to logic 1 (having variation). In the same manner, the remote multiple image processing apparatus according to the embodiment of the invention can reduce the time for comparing the flags to accelerate the processing speed.

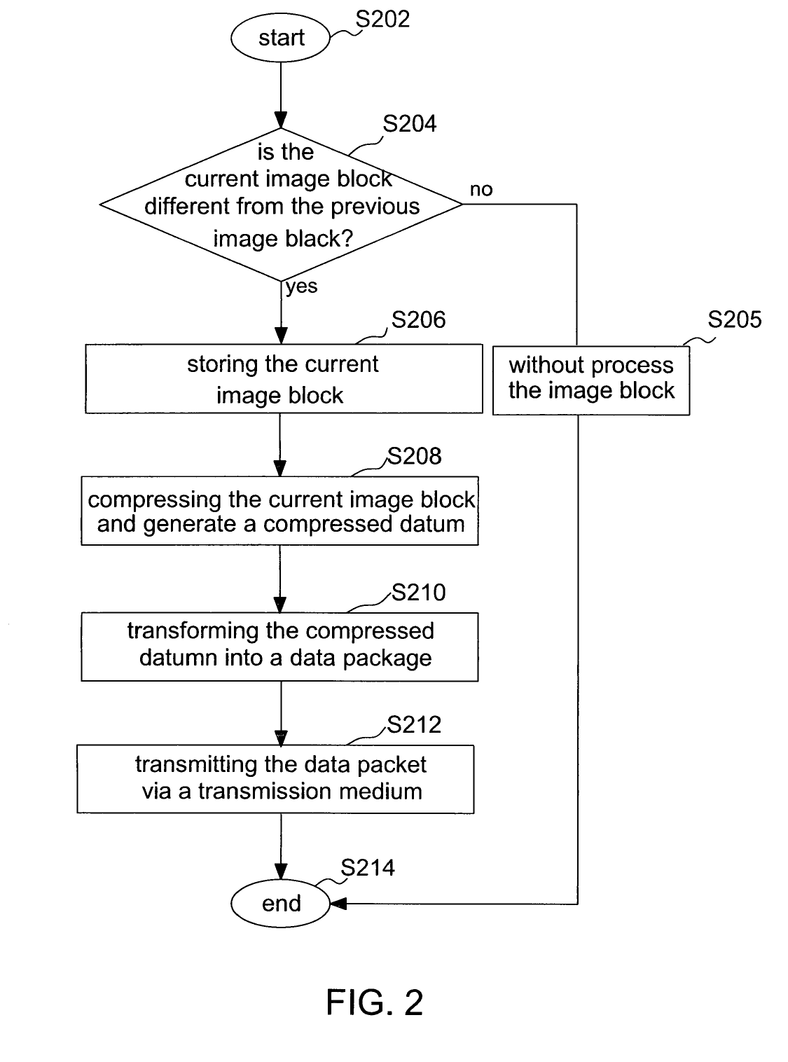

FIG. 2 shows a flow chart illustrating the remote multiple image processing method according to one embodiment of the invention.

Step S202: start;

Step S204: determining if the current image block is different from the previous image block and then jumping to S206 if yes and to S205 if no;

Step S205: jumping to Step S214 without processing the image block;

Step S206: storing the current image block;

Step S208: compressing the current image block and generating a compressed datum;

Step S210: transforming the compressed datum into a data packet;

Step S212: transmitting the data packet via a transmission medium;

Step S214: end.

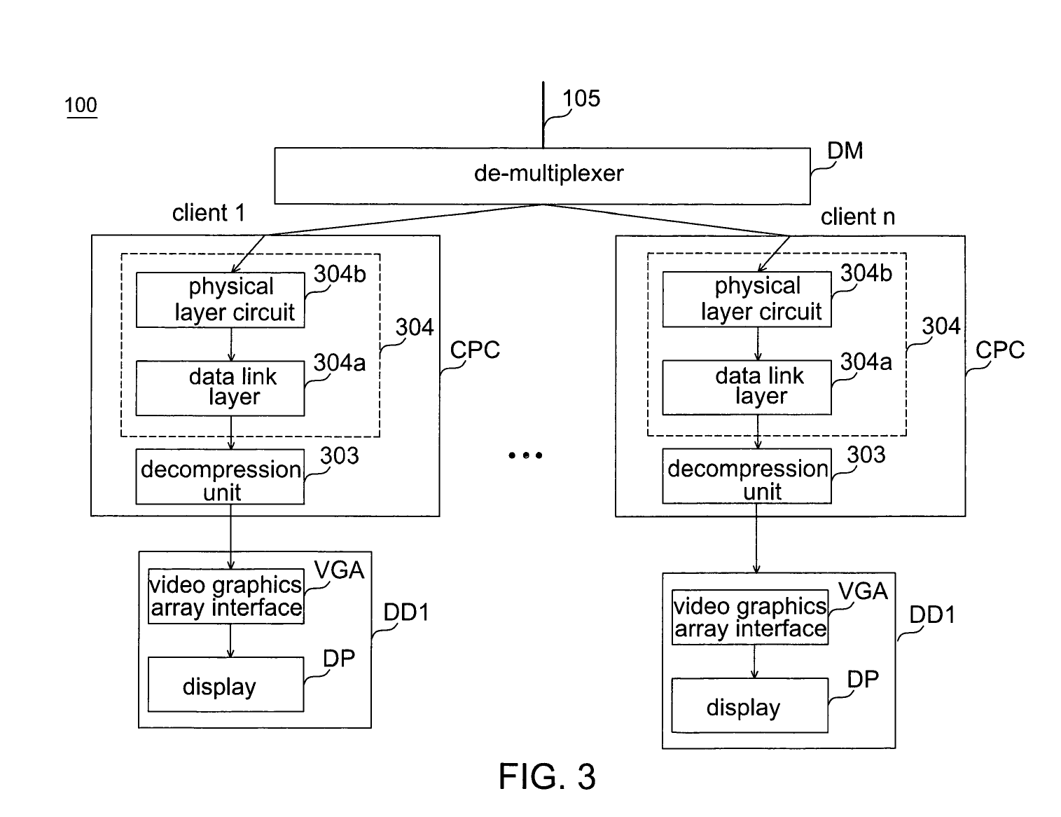

FIG. 3 shows a schematic diagram illustrating the client of the remote multiple image processing apparatus 100 according to one embodiment of the invention. The client of the remote multiple image processing apparatus 100 comprises a de-multiplexer DM and at least a client processing circuit CPC. Certainly, if there is only one client, the de-multiplexer DM can be omitted. The de-multiplexer DM is used to transmit the data packet N from the server to the client designated by the server according to the command from the server. Each client processing circuit CPC includes a transmission unit 304 and a decompression unit 303. The transmission unit 304 includes a physical layer circuit 304b and a data link layer 304a. The client receives the data packet N thereof and transforms the data packet N into the image frame M via the physical layer circuit 304b, the data link layer 304a, and the decompression unit 303. The image frame M is then transmitted to the display device DP for display via the video graphics array (VGA) interface of the display device DD. It should be noted that those who are skilled in the art can realize the operational methods of the transmission unit 304 and decompression unit 303 from the above description and the detailed description will not be given hereafter. The interface used by the display device DD can be any other current or future interface, such as D-sub interface, S-video interface in Video Graphics Array interface (VGA), AV terminal interface, 3RCA (YUV, YpbPr, or YCbCr) terminal interface or BNC terminal interface, or digital video interactive (DVI) interface, etc.

The server and the client of the remote multiple image processing apparatus according to the embodiments of the invention utilize the transmission medium, de-multiplexer, and client processing circuit to operate in coordination so that each remote user can share the resource of the same computer only by connecting the display device with a remote client processing apparatus. Since the server of the remote multiple image processing apparatus utilizes the compression technology to accelerate the transmission rate, multiple users can remotely share the resource of the same computer under the three dimensional image mode so that each display device can function like a computer for each user. Thus, for an office or home local area network, multiple computers and multiple display devices are not needed and space for multiple computers can be saved because only one computer and multiple display devices are needed. The usage of apparatuses can be more effectively. Besides, the remote multiple image processing apparatus and method thereof according to the embodiments of the invention not only reduce the bandwidth usage during transmission but also perform long-distance data transmission via the transmission medium, such as network cables or optical fibers on the premise of low cost. Furthermore, in the transmission device of the embodiment, the physical layer circuit can be implemented by the current device having the physical layer circuit to achieve the purpose of reducing production cost.

Although the present invention has been fully described by the above embodiments, the embodiments should not constitute the limitation of the scope of the invention. Various modifications or changes can be made by those who are skilled in the art without deviating from the spirit of the invention.

What is claimed is:

1. A remote multiple image processing apparatus, comprising:
a graphic processing unit for receiving at least an image frame including a plurality of image blocks and for determining the degree of the difference between the current input image block and the previous input image block;
a memory unit, coupling to the graphic processing unit, for storing the image blocks
an image compression unit, coupling to the memory unit, for compressing the image blocks and generating at least a compressed datum;
a transmission unit, coupling to the image compression unit, for transforming the compressed datum into at least a data packet;
a transmission medium for outputting the data packet.

2. The apparatus according to claim 1, wherein the current input image block and the previous input image block each comprise a color datum and a flag datum and, when the difference between the color datum of the current input image block and that of the previous input image block reaches a preset level, the graphic processing unit changes the flag datum stored in the memory unit and the image compression unit compresses the current input image block according to the flag datum.

3. The apparatus according to claim 2, wherein, when the difference between the color datum of the current input image block and that of the previous input image block does not reach the preset level, the graphic processing unit maintains the flag datum stored in the memory unit and the image compression unit does not compress the current input image block according to the flag datum.

4. The apparatus according to claim 3, wherein the transmission unit does not transmit the data packet to the transmission medium.

5. The apparatus according to claim 1, wherein the current input image block comprises a pixel of the current input image, the previous input image block comprises a pixel of the previous input image, and the positions of these two pixels are substantially the same.

6. The apparatus according to claim 1, wherein the current input image block comprises a plurality of pixels of the current input image, the previous input image block comprises a plurality of pixels of the previous input image, and the positions of every two pixels of the current and previous input images are substantially the same.

7. The apparatus according to claim 1, wherein the current input image block comprises all pixels of the current input image and the previous input image block comprises all pixels of the previous input image.

8. The apparatus according to claim 1, wherein the color datum comprises red, green, blue (RGB) primary color data.

9. The apparatus according to claim 1, wherein the memory unit is implemented by a dynamic random access memory (DRAM).

10. The apparatus according to claim 1, wherein the memory unit is implemented by a frame buffer built in the graphic processing unit.

11. The apparatus according to claim 1, wherein the graphic processing unit receives the current input image block and the previous input image block via a peripheral component interconnect express (PCIe) interface or a peripheral component interconnect (PCI) interface.

12. The apparatus according to claim 1, wherein the transmission unit comprises:
at least a data link layer for processing the compressed datum to generate the data packet; and
at least a physical layer circuit coupling to the data link layer for processing and transmitting the data packet.

13. The apparatus according to claim 12, wherein the data packet comprises a header, the compressed datum, and a cyclic redundancy check (CRC) or error correction code (ECC).

14. A remote multiple image processing method, comprising:
receiving at least an image frame including a plurality of image blocks and determining the degree of the difference between the current input image block and the previous input image block wherein the current input image block and the previous input image block each comprise a color datum and a flag datum;
updating the flag data and compressing the current input image block according to the flag data to generate a compressed datum when the color data of the current input image block and the previous input image block are different;
transforming the compressed datum into a data packet and thereby outputting via a network cable or optical fiber.

15. The method according to claim 14, wherein, when no difference between the color datum of the current input image block and that of the previous input image block, the flag data are not updated, the current input image block is not compressed, and the current image data are not outputted.

16. A remote multiple image processing apparatus, comprising:
a de-multiplexer for receiving at least a data packet and for outputting the data packet according to an command; and
at least a client processing circuit, comprising:
at least a transmission unit for receiving the data packet and transforming the data packet into a compressed datum; and
at least a de-compression unit coupling to the transmission unit for decompressing the compressed datum to generate an image frame datum.

17. The apparatus according to claim 16, wherein the transmission unit comprises:
at least a physical layer circuit for processing and transmitting the data packet; and
at least a data link layer coupling to the physical layer circuit for processing the data packet to generate the compressed datum.

18. The apparatus according to claim 16, wherein the image datum is outputted to a display device.

19. The apparatus according to claim 18, wherein the display device comprises an image interface and a display.

20. The apparatus according to claim 19, wherein the image interface is selected from the group consisting of the following or combination thereof: D-sub interface, S-video interface in Video Graphics Array (VGA) interface, AV terminal interface, 3RCA (YUV, YpbPr, or YCbCr) terminal interface or BNC terminal interface, or digital video interactive (DVI) interface.
